(19) United States
(12) Patent Application Publication
(10) Pub. No.: US 2016/0050481 A1
(43) Pub. Date: Feb. 18, 2016

(54) Earphone Assembly Organizer Apparatus and Method

(71) Applicant: Clint Moats, Roanoke, VA (US)

(72) Inventor: Clint Moats, Roanoke, VA (US)

(21) Appl. No.: 14/808,816

(22) Filed: Jul. 24, 2015

Related U.S. Application Data
(60) Provisional application No. 62/037,018, filed on Aug. 13, 2014.
(60) Provisional application No. 62/112,351, filed on Feb. 5, 2015.

(51) Int. Cl. H04R 1/10

(52) U.S. Cl. CPC H04R 1/1033

(57) ABSTRACT

An earphone assembly organizer apparatus and a method for organizing, storing, and protecting earphone assemblies comprising a body for stowing an earphone assembly and a face having two oval openings providing access to two storage cavities for stowing earphones, whether earbuds or ear plugs. Each earphone is inserted edgewise into an opening and tipped down into a storage cavity. Once inserted, the earphone may be rotated to secure the earphone within a storage cavity of the organizer. The apparatus further includes a feature for propping a cell phone or other device at various angles for display and use. The cords of the earphone assembly are wrapped and secured behind the face of the apparatus to avoid obstructing novelty of design or decoration.

### CROSS REFERENCE TO RELATED APPLICATIONS

This application claims the benefit of U.S. Provisional Application No. 62/037,018, filed Aug. 13, 2014, and of U.S. Provisional Application No. 62/112,351, filed Feb. 5, 2015.

### STATEMENT REGARDING FEDERALLY SPONSORED RESEARCH OR DEVELOPMENT

Not Applicable.

### THE NAMES OF THE PARTIES TO A JOINT RESEARCH AGREEMENT: Not Applicable. INCORPORATION-BY-REFERENCE OF MATERIAL SUBMITTED ON A COMPACT DISC

Not Applicable.

### FIELD OF THE INVENTION

The invention relates to peripherals for electronic devices. More particularly, the invention relates to an apparatus and method for organizing, storing, and protecting earphone assemblies.

### BACKGROUND

Many earphone cord organizers fail to provide adequate protection for the earpiece components of the earphone assembly. The emphasis of such organizers tends to be directed toward wrapping the cord in a tight bundle. Earphones include, among other designs, earbuds and earplugs. For example, with the continued growth of the use of cell phones, e.g., IPHONES by APPLE CORPORATION, the corollary growth of the use of earphones has skyrocketed.

In many earphone cord organizers, although the earphone cord may be bundled, the earphones can be left dangling loose from the organizer where an impact can damage the earphones. Packaging associated with initial sale of the earphone assembly may provide a temporary solution, but the packaging is not sufficiently robust nor designed for portable and convenient use. Additionally, existing cord organizers may lack aesthetic appeal since functional requirements, i.e., wrapping the cord, may supersede form or ornamental design. Further, existing cord organizers will focus strictly on wrapping the cord, rather than securing the cord and the earphones simultaneously.

While earphone assemblies may withstand some abuse, earphones do contain sensitive electronic audio components. Earphone assembly organizers that do not protect the earphones themselves increase the likelihood that the earphone assembly will have a short life cycle. In use, wrapping the cord while leaving the earphones dangling is likely to cause breakage where the cord meets an earphone stem. Cord damage is a major culprit in the case of broken earphones; improper storage leads directly to cord damage. Existing cord organizers may be built of hard, thin materials that too easily allow a user to wrap the earphone cords too tightly, causing excessive bending, stretching and breakage of the earphone cords. Hence, audio can be either nonexistent or intermittent, generating unpleasant static or interrupted audio generation, neither of which is desirable. In practice, earphone assemblies are frequently not stored properly and are simply wrapped and placed in a user's pocket. Invariably, the earphone cords weaken and break due to constant manipulation and bending.

Consumers clearly want to avoid tangling or damaging their earphone assemblies. The combination of form and function is important to consumers. It would be beneficial if an earphone assembly organizer incorporated the earphones themselves into the design of the organizer in an appealing manner. Additionally, it would be beneficial if users could express their personal interests via their earphone assembly organizer. It would be beneficial if an earphone assembly organizer could comprise a configuration to support a variety of designs or characteristics that let users express themselves in numerous ways.

Hence, a need exists for an earphone assembly organizer that can simultaneously satisfy functional requirements while still delivering an attractive form to support variable designs. Further, a need exists for such an organizer where protection of the earphones is an important functional requirement. Additionally, a need exists for such an organizer where the earphone assembly can be quickly and easily stored and/or removed from the organizer to increase convenience of use. Still further, a need exists for such an organizer where the user can be confident that the earphone cord and the earphones are stored in a protective manner that will lessen the probability of damage and extend the useful life of the earphone assembly. Still further, a need exists for an earphone assembly organizer where the earphones themselves may be secured within the organizer while the remainder of the earphone cord is wrapped about the organizer.

### SUMMARY

The present invention comprises an apparatus and method to easily organize, wrap, and secure earphone cords and to protect earphones of various styles. An embodiment of the invention allows the earphones of an earphone assembly to be positioned during storage in the organizer to accent a top face design of the organizer. In particular, the organizer includes a face design that suggests that an animal, person, or fictitious character is using the earphones. When the earphones are stored in their proper locations in the organizer, it appears that the character represented in the face design is using the earphones.

The earphone assembly organizer according to the present invention is designed to uniquely receive and store the earphones and associated cord assembly. The organizer includes receptacles resembling ear cavities to secure and protect multiple types of earphones, including earplugs and earbuds. The cord of the earphone assembly is wrapped around the body of the organizer for storage. To avoid damage to the earphone cord while stored on the organizer, the body of the organizer has a radius of curvature around the surface portion where the cord is wrapped such that the wrapped cord does not exceed a minimum bending radius, beyond which, damage is more likely to occur to the conductors in the earphone cord. The organizer includes a narrow retention slot to receive, secure and protect the jack end of the cord. The cord can be secured and unsecured quickly, making the organizer easy and convenient to use.

The organizer may also include a detachable carry loop. One attaches the loop to the body by pressing a portion of the loop through the same narrow retention slot used to secure the earphone cord. The organizer can then hang from the loop. The carry loop allows a user to carry the organizer by hand, to attach it to a belt or backpack, or to hang the organizer on a wall.

The organizer includes a phone stand brace. The brace may be attached to the loop for safekeeping so that it does not easily become detached or lost during transport. The brace serves to hold a mobile phone in a particular orientation on the organizer for easy viewing.

### BRIEF DESCRIPTION OF THE SEVERAL VIEWS OF THE DRAWINGS

These and other features, aspects and advantages of various embodiments of the present invention will become better understood with regard to the following description, appended claims, and accompanying drawings where:

FIG. 1 is a perspective view of an earphone assembly organizer according to an exemplary embodiment of the invention;

FIG. 2 is an exploded view of the earphone assembly organizer of FIG. 1;

FIG. 3 is a rear view of the face of the earphone assembly organizer thereof;

FIG. 4 is a perspective view of one form of a typical earphone assembly;

FIG. 5A is a front view of the face of the earphone assembly organizer of FIG. 1 with an installed earphone assembly having earplugs;

FIG. 5B is a front view of the face of the earphone assembly organizer with an installed earphone assembly having earbuds;

FIG. 6A is a side perspective view of the earphone assembly organizer with an earphone assembly partially installed;

FIG. 6B is a top perspective view of the earphone assembly organizer with an earphone assembly partially installed;

FIG. 6C is a perspective view of the earphone assembly organizer in an inverted position with an earphone assembly fully installed;

FIG. 7 is a partial view of the bottom of the earphone assembly organizer including a carry loop;

FIG. 8 is a side view of the earphone assembly organizer inverted to serve as a stand for display purposes;

FIG. 9A is a side sectional view of the organizer taken along section line 9-9 of FIG. 3 showing an earbud during insertion;

FIG. 9B is a side sectional view of the organizer taken along section line 9-9 of FIG. 3 showing a fully-inserted earbud secured within the organizer;

FIG. 10 is the side sectional view of the FIG. 9 further illustrating a compressible insert associated with the storage cavity of the organizer;

FIG. 11 is an illustration of the rotational method of engagement of earbuds in the storage cavities of the organizer;

FIG. 12 is a top perspective view of an earphone assembly organizer according to a second exemplary embodiment of the invention;

FIG. 13 is a perspective view of the earphone assembly organizer of FIG. 12 in an inverted position;

FIG. 14 is an exploded view thereof;

FIG. 15 is an enlarged exploded view of the body and cavity inserts of the earphone assembly organizer of FIG. 12;

FIG. 16A is a left side elevation view of a cavity piece of the earphone assembly organizer of FIG. 12;

FIG. 16B is a front elevation view thereof;

FIG. 16C is a right side elevation view thereof;

FIG. 16D is a top plan view thereof;

FIG. 16E is a bottom plan view thereof;

FIG. 17 is sectional view of the assembled earphone assembly organizer taken along the section line 17-17 of FIG. 13;

FIG. 18 is a sectional view of the assembled earphone assembly organizer taken along the section line 18-18 of FIG. 13.

FIG. 19 is a perspective view of the face of the earphone assembly organizer according to a third embodiment of the invention;

FIG. 20 is a perspective view the earphone assembly organizer shown in FIG. 19 in an inverted position;

FIG. 21 is an exploded view of the earphone assembly organizer of FIG. 20;

FIG. 22 is a perspective view of the body of the earphone assembly organizer of FIG. 21;

FIG. 23 is a front elevation view of the earphone assembly organizer of FIG. 20;

FIG. 24 is a sectional view of the earphone assembly organizer taken along the section line 24-24 of FIG. 23.

FIG. 25 is a sectional view of the earphone assembly organizer taken along the section line 25-25 of FIG. 23.

FIG. 26 is a left side elevation view of the earphone assembly organizer of FIG. 20;

FIG. 27 is a sectional view of the earphone assembly organizer taken along the section line 27-27 of FIG. 26; and,

FIG. 28 is that same sectional view shown in FIG. 27 further including foam inserts.

The accompanying drawings numbered herein are given by way of illustration only and are not intended to be limitative to any extent. Commonly used reference numbers identify the same or equivalent parts of the claimed invention throughout the several figures.

### OBJECTIVES

A first objective of an embodiment of the present invention is to provide an apparatus to easily store, organize, and protect earphone assemblies when not in use.

Another objective is to provide an apparatus capable of storing and protecting a wide variety of earphone assembly types, including those with earplug and earbud configurations.

Another objective is to provide an earphone assembly organizer that can also function as a stand for a mobile phone.

Another objective is to provide an earphone assembly organizer that ensures that the cord portion of an earphone assembly is less likely to be damaged when the cord is wrapped about the organizer.

Another objective is to provide an organizer that is easily transported and can be carried by hand or attached to a belt, purse, or backpack.

Another objective is to provide an organizer that is configurable and aesthetically appealing.

Another objective is to provide an organizer where an aesthetic portion can be easily changed to illustrate different characters or designs.

Another object of the present invention is to provide an organizer where the interconnect between the earphone cord and the earpiece is sufficiently supported during storage to reduce the likelihood of breakage.

Other objects of the invention will become apparent through further review of the present disclosure.

### DETAILED DESCRIPTION

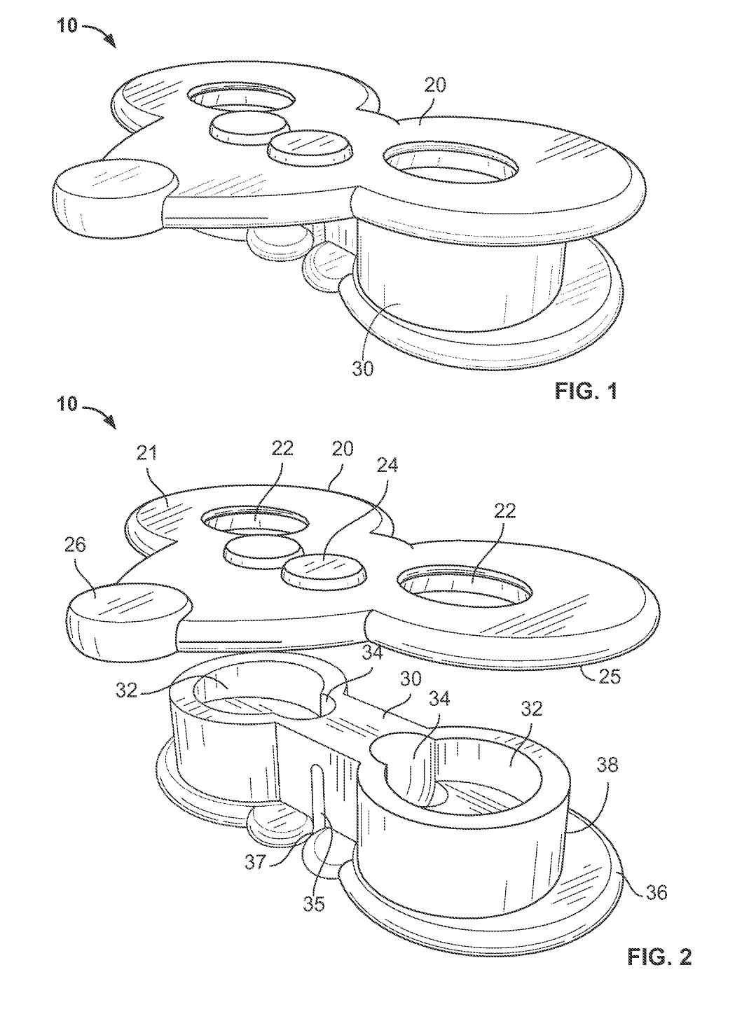

FIGS. 1 through 28, wherein like parts are designated by like reference numerals throughout, illustrate example embodiments of an earphone assembly organizer according to the present invention. Although the present invention will be described with reference to the example embodiments illustrated in the figures, it should be understood that many alternative forms can embody the present invention, One of skill in the art will additionally appreciate. different ways to after the parameters of the embodiments disclosed, such as the size, shape, or type of elements or materials, in a manner still in keeping with the spirit and scope of the present invention.

Referring to FIG. 1, a first exemplary embodiment of an earphone assembly organizer 10 according to the invention is shown. For succinctness, the earphone assembly organizer 10 will hereinafter be referred to as the earphone assembly organizer 10 or organizer 10. The earphone assembly organizer 10 comprises a face 20 and a body 30. In this first exemplary embodiment, the face 20 of the earphone assembly organizer 10 is designed to somewhat resemble the face of a mouse. The face 20 and body 30 may be manufactured as one unitary piece, as shown in FIG. 1, for example, using injection molding. Alternatively, as shown in FIG. 2, the face 20 and body 30 may comprise two separate elements, which are engaged to form one assembly using various assembly means. Such assembly means can include thermal joining, adhesives, mechanical integration, friction fit, arid the like, The face 20 and body 30 can be formed of hard or rigid material, and material having a certain amount of flexibility, including but not limited to plastic, rubber, composites, synthetic materials, natural materials, wood and the like. The organizer 10 may likewise be made from metal or composites while still providing desired functionality, One of skill in the art will appreciate that any number of different materials may be utilized, such that the present invention is by no means limited to those specifically listed herein.

Now referring to FIG. 2, an exploded view of the earphone assembly organizer 10 is shown. The face 20 includes a front surface 21 and rear surface 25. The face 20 is penetrated by two oval openings 22. The body 30 includes a base 36 from which a wrapping surface 38 extends. The wrapping surface 38 is sized to receive multiple wrappings of an earphone assembly 40 (FIG. 4) for storage. The radius of curvature of the wrapping surface 38 is preferably greater than the minimum radius of curvature to avoid damaging the earphone cord assembly 40 (FIG. 4).

The body 30 is bisected by a retention slot 35 sized to receive and hold earpiece cords 45 and the main cord 47 of the earphone assembly 40. In another version, the retention slot may be sized to receive and hold an earphone jack 49 of the earphone assembly 40. A smaller crimping portion 37 of the retention slot 35 is sized to allow insertion of the earpiece cords 45 and the main cord 47 within the retention slot 35 while ensuring that the earpiece cords 45 and the main cord 47 of the earphone assembly 40 are securely retained about the wrapping surface 38 and in the retention slot 35.

The face 20 and front surface 21 are configurable, changeable and replaceable to provide a plurality of design options according to the interests and personal preferences of a purchaser. For example, the face 20 may have many different shapes and designs, including utilitarian plain designs with less resemblance to a character and lacking other embellishment. The face 20 and base 36 support application of various brands and logos. Irrespective of the design or shape of the face 20, the face 20 is sized to accommodate the openings 22. Although the design of the face 20 may vary, the size and dimension of the openings 22 will vary to accommodate and receive differently sized earplugs 43 and ear buds of an earphone assembly 40.

The openings 22 in the face 20 are similar, and will be described simultaneously herein. The openings 22 are shown as preferably having a slightly ovular shape. The openings 22 may have other shapes so long as the geometric relationship between the size and shape of the openings 22 and the size and shape of the earbuds 44 is maintained.

As shown in FIG. 2, where the face 20 is removable from the body 30, a different face having a different design may be used to replace the original face 20, thus providing a user with variability in the design and material comprising the face 20. In one version, the face 20 includes two circular protrusions 24 and a nose protrusion 26, which convey the sense of the two eyes and nose of a mouse, respectively. Preferably, the protrusions 24, 26 are sized to keep the earphone assembly organizer 10 level when flipped upside down to serve as a mobile phone stand. Although shown as circular in shape, additional shapes may be used to form the protrusions 24, 26 and additional protrusions may be included to complement the aesthetic aspect of the organizer 10. Additionally, in another aspect, the protrusions 24, 26 extend a distance to allow the earphone assembly organizer 10 to be used while the earphone assembly 40 is actually stored on the organizer 10. In this aspect, the protrusions 24, 26 will protrude a distance such that the protruding earphone assembly 40 does not interfere with the organizer 10 when used as a phone stand in an inverted position.

In other versions, the face 20 may be flat without protrusions. In other versions, the face 20 may include indentations, grooves or other decorative features used to convey the sense of a character or other image. A plethora of different design elements may be incorporated in the face 20 according to a user's interests.

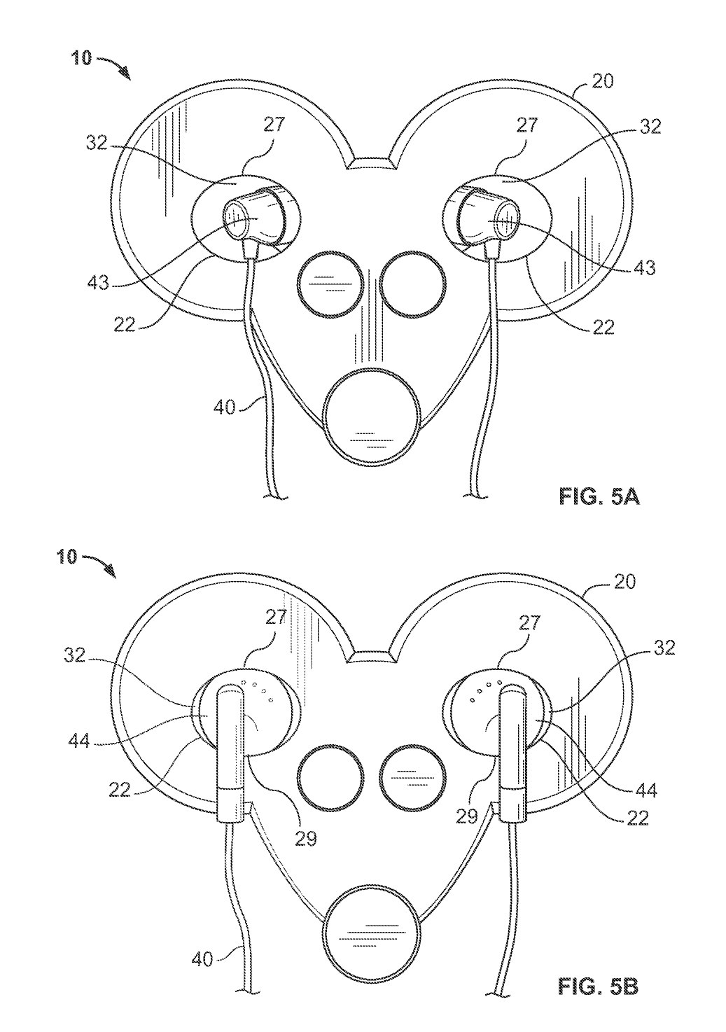

The body 30 of the organizer 10 is preferably symmetric, forming two opposite but identical storage cavities 32 for receiving earbuds 44 of an earphone assembly 40 (see FIG. 4). The earbuds 44 are inserted through the openings 22 and into the cavities 32 to stow and protect the earbuds 44. The storage cavities 32 include recesses 34 shaped and adapted for securing earplugs 43 as well. The earplugs 43 are secured via size differential and frictional engagement. The recesses 34 are shaped to accommodate and frictionally engage earplugs 43 (FIG. 5A). The recesses 34 are likewise sized to allow rotational insertion of earbuds 44 (FIG. 5B).

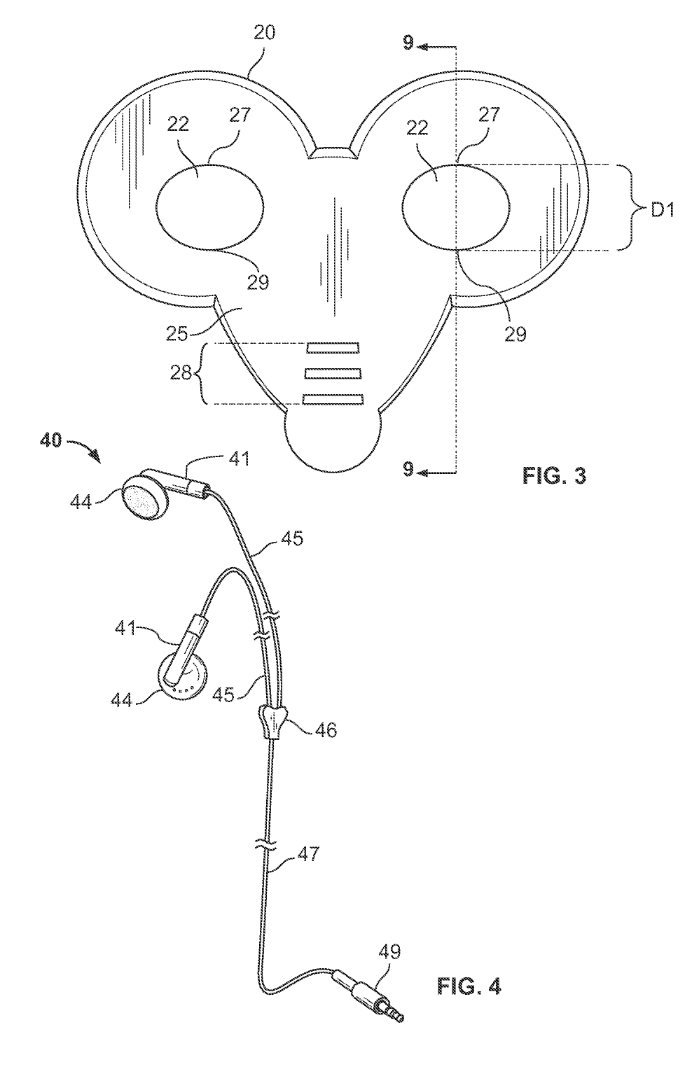

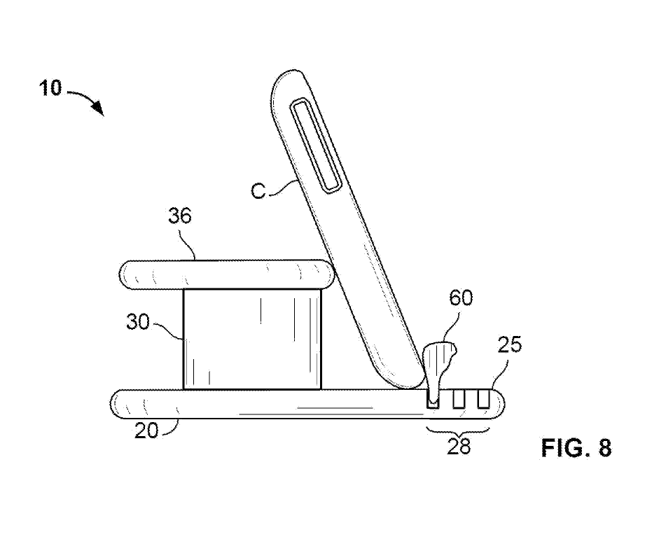

Referring to FIG. 3, a rear view of the face 20 of the organizer 10 is shown. The rear surface 25 of the face 20 includes one or more notches 28. The notches 28 are sized to receive a brace 60 (FIG. 8) to support a cell phone C at an angle on the organizer 10. Each oval opening 22 includes an upper edge 27 and a lower edge 29. The distance between the upper edge 27 and lower edge 29 is diameter D1 of the openings 22.

Referring to FIG. 4, a typical earphone assembly 40 used with a mobile phone or other music player is shown. An earphone assembly 40 is typically configured to include two earbuds 44 having stems 41, two earpiece cords 45 merging at a Y-junction 46, a main cord 47, and an earphone jack 49. The earphone assembly 40 can be of varying lengths. Likewise, the organizer 10 is scalable in size and dimension to accommodate varying lengths of earphone assemblies 40.

Now referring to FIGS. 5A and 5B, we illustrate two views of the face 20 of the organizer 10, wherein two different types of earphones may be accommodated in the openings 22. Note, that in this example embodiment, the face 20 is designed to represent the face of a mouse wherein the mouse appears to be using the earphones. The face 20 can be changed to represent other characters, fictional and otherwise, to allow personalization and customization according to user preferences. Texture color and other design elements of the face 20 may likewise be changed.

In FIG. 5A, the earphone assembly organizer 10 holds plug-type receivers 43, hereinafter, earplugs 43. The earplugs 43 are inserted into the openings 22 to be secured within the storage cavities 32 through frictional engagement with the recesses 34. In FIG. 5B, the earphone assembly organizer 10 holds earbuds 44, a different type of earphone. When the earphone assembly 40 includes earbuds 44, the earbuds 44 may be tilted and twisted slightly to fit through the openings 22 and secured within the cavities 32. Earplugs 43 do not need to be rotated to be stored within the organizer 10; earplugs 43 are pushed into the recesses 34.

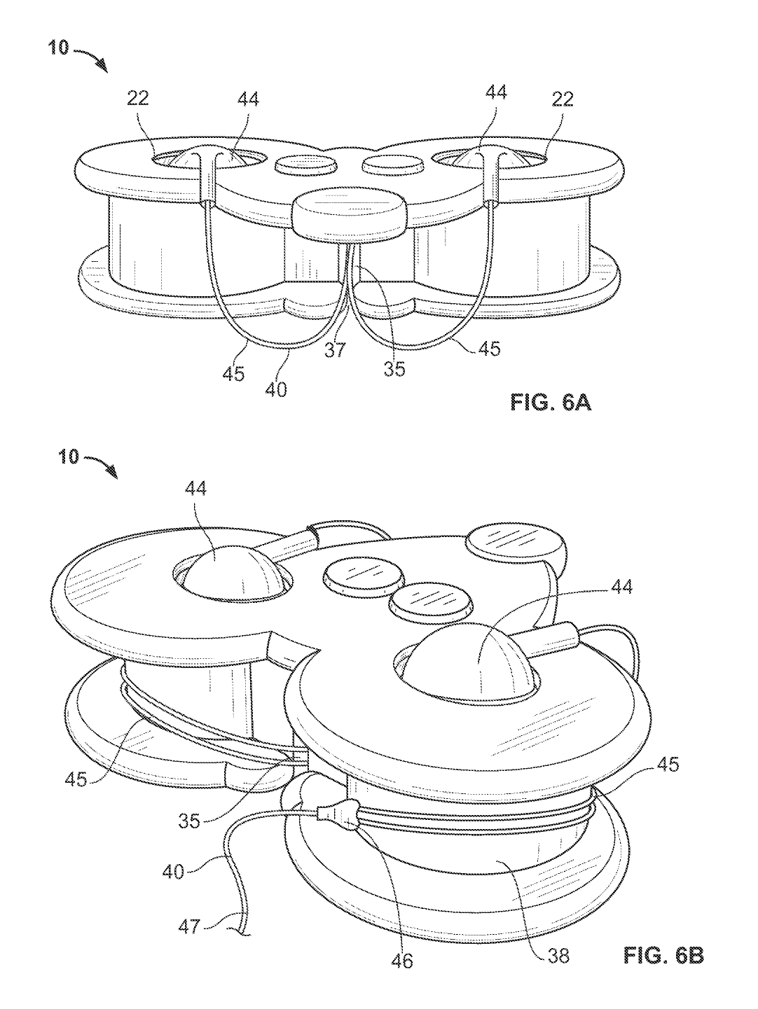

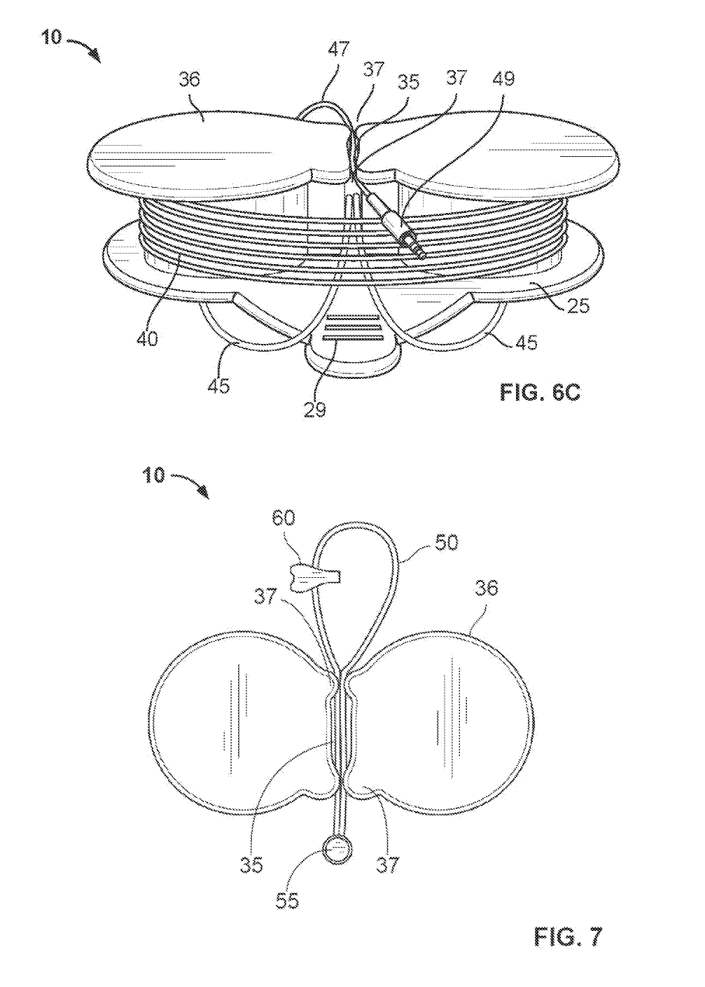

Referring now to FIGS. 6A, 6B, and 6C, we illustrate a method according to the present invention by which a user may install an earphone assembly 40 on the earphone assembly organizer 10. FIG. 6A is a front perspective view of the organizer 10 with a partially wrapped earphone assembly 40 engaged during a first stage of stowing the assembly 40. After securing earbuds 44 in openings 22, the two individual earpiece cords 45 are wrapped underneath the face 20 and towards the retention slot 35 in the body 30. The two individual earpiece cords 45 are pressed down through the crimping portion 37 into the retention slot 35 in the body 30 while leaving enough slack that the individual earpiece cords 45 are not under excessive tension or excessively bent while in storage. The earbuds 44 will not fall out of the openings 22 during the process of stowing the assembly 40 on the organizer 10. The crimping portion 37 is sized to allow the earpiece cords 45 to press fit through into the retention slot 35 during installation; thus, the earpiece cords 45 will not fall out of retention slot 35 without applying some tension on the earpiece cords 45 to move them back through the crimping portion 37.

Referring now to FIG. 6B, a rear perspective view of the organizer 10 with a partially wrapped earphone assembly 40 at a second stage of the method is shown. The individual earpiece cords 45 are wrapped around the body 30 along the wrapping surface 38. When the individual earpiece cords 45 merge at the Y-junction 46 to form the main cord 47, the main cord 47 continues to be wrapped around the wrapping surface 38. The face 20 and the base 36 of the body 30 serve as restrictive guides to ensure that the wrapped earphone assembly 40 remains in place on the body 30 of the organizer 10 while being wrapped on the organizer 10 and during storage.

Referring next to FIG. 6C, a bottom perspective view of the organizer 10 in an inverted position with a fully wrapped earphone assembly 40 at a last stage of the method is shown. Once the main cord 47 is nearly fully wrapped around the wrapping surface 38, the last portion of the main cord 47 near the earphone jack 49 is pressed through the crimping portion 37 into the retention slot 35. The crimping portion 37 is sized so that additional force is required to press the main cord 47 through the crimping portion 37 and into the retention slot 35. The crimping portion 37 prevents the main cord 47 from coming loose while the organizer 10 is in use. The earphone assembly organizer 10 and earphone assembly 40 may then be handled, stored, transported, or displayed.

The earphone assembly 40 may be removed from the earphone assembly organizer 10 by performing the installation steps described above in reverse order. Referring again to FIG. 6C, to remove the earphone assembly 40, the main cord 47 near the earphone jack 49 is first pulled out of the retention slot 35 through the crimping portion 37. Referring again to FIG. 6B, the main cord 47 and individual earpiece cords 45 are unwrapped from the wrapping surface 38. Next, the individual earpiece cords 45 are removed from the retention slot 35 through the crimping portion 37. The earbuds 44 are then removed from the oval openings 22. For this example, we have used earbuds 44, and hence, for final removal, the earbuds 44 need to be rotated and tilted or twisted slightly to remove them from the organizer cavities 32. This process of rotation to facilitate storage and/or removal of the earbuds 44 in the organizer 10 is described in greater detail herein and in reference to FIG. 11.

Now referring to FIG. 7, a bottom view of the earphone assembly organizer 10 with an installed carry loop 50 is shown. The carry loop 50 is engaged within the retention slot 35 on the body 30 and is used to lift and hold the organizer 10 upright. A stop 55 is provided on the carry loop to prevent the carry loop 50 from being pulled through the retention slot 35 while carrying the organizer 10. A brace 60 used for supporting a cellphone C may be attached to the loop 50 for storage.

Now referring to FIG. 8, a side elevation view of the earphone assembly organizer 10 in an inverted position being used as a stand for a cellphone C is shown. In this aspect, the earphone assembly 40 has been removed so that the face 20 can rest evenly on a surface. The earphone assembly organizer 10 may then be used to hold a cellphone C at various angles for viewing and operation. To use the organizer 10 as a stand, the earphone assembly organizer 10 is placed upside-down so that the face 20 is below the body 30 and base 36, resting on a supporting surface such as a table or desktop. The brace 60 may be pressed into one of the notches 28 on the rear surface 25 of the face 20. Fewer or more notches 28 may be used to provide differing angles of repose for the cellphone C. A cell phone C, another electronic device or any object that a user may wish to support in the stand may then be placed upright on the rear surface 25 and against the base 36, constrained by the placement of the brace 60 in one of the notches 28. The lower portion of the cellphone C rests against the brace 60 to maintain its position. The brace 60 may be moved to any of the notches 28 to change the angle of repose of the cellphone C.

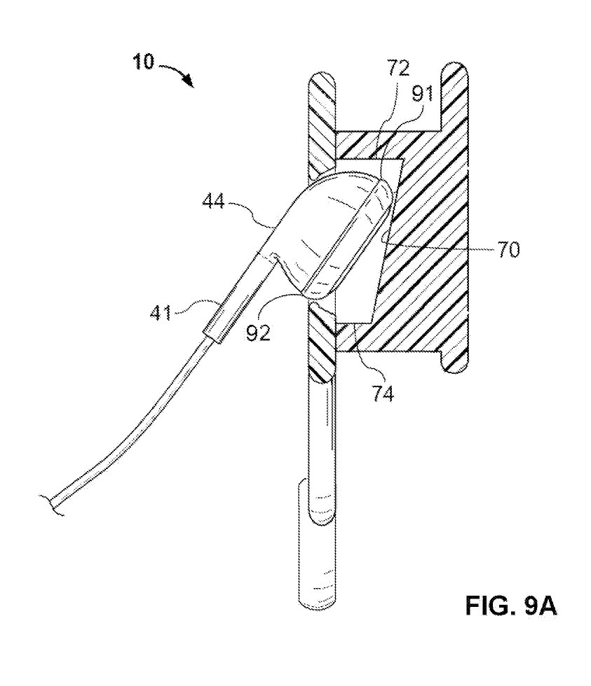

Referring to FIG. 9A and FIG. 9B, sectional views of the organizer 10 taken along section line 9-9 of FIG. 3 are shown. These views depict the means by which each earbud 44 is captured within a storage cavity 32 of the organizer 10. For each storage cavity 32, a pitched floor 70 forms a well in the cavity 32 having a deeper portion 72 and a shallower portion 74. The pitched floor 70 is angled to allow a first edge 91 of an earbud 44 to be first inserted into the deeper portion 72 of the cavity 32 so that an opposing edge 92 of the earbud 44 may then pass into the storage cavity 32 through the opening 22. The opposing edge 92 of the earbud 44 is then secured in the shallower portion 74 with the first edge 91 and the opposing edge 92 of the earbud 44 fully constrained by the opening 22 in the face 20.

D1 is the vertical diameter of the opening 22; D2 is the diameter of the earbud 44. D2 is greater than D2 in the various embodiments of the invention, thus ensuring that the earbud 44 is retained in its storage cavity 32.

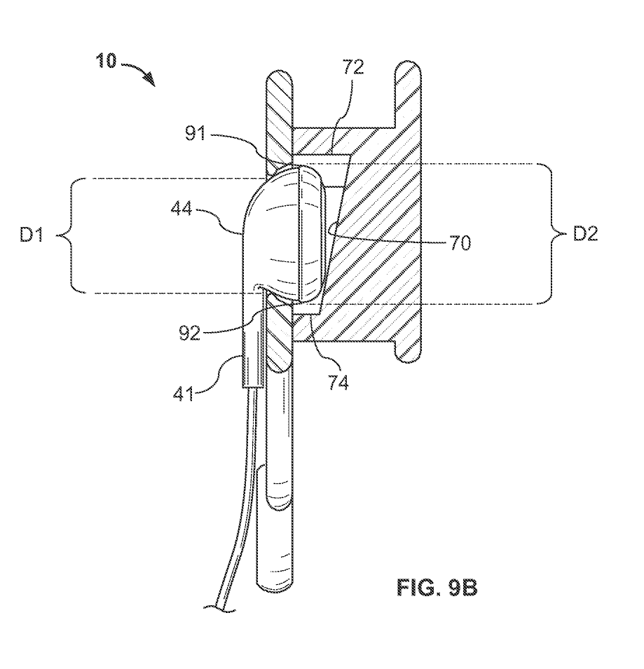

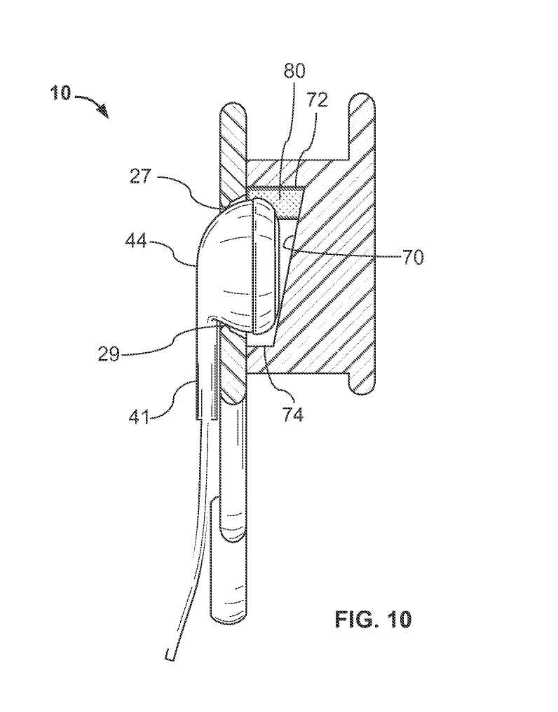

Referring now to FIG. 10, in another version, the cavity 32 includes a compressible insert 80 installed adjacent the deeper portion 72 of the cavity 32. The compressible insert 80 allows the first edge 91 of an earbud 44 to be pressed into the compressible insert 80 to allow the opposing edge 92 of the earbud 44 to be tipped into the cavity 32 through the opening 22. In this version, it is not necessary to rotate the earbud 44 to insert and store the earbud 44 in the cavity 32. The rotational and compression feature may be integrated to create a hybrid version of the earphone assembly organizer 10 using rotation of the earbud 44 and compression of compressible insert 80 to stow the earbud 44.

Where a compressible insert 80 is incorporated in storage cavity 32 of the organizer 10, once the earbud 44 is released, the compressible insert 80 rebounds and forces the earbud 44 downward to snugly engage in the cavity 32. The first edge 91 and opposing edge 92 of the earbud 44 prevents the earbud 44 from falling out of the cavity 32 since the distance D1 between the upper edge 27 and lower edge 29 of the oval opening 22 is smaller than the diameter D2 of the earbud 44 as defined by the distance between first edge 91 and opposing edge 92.

The functional aspect of the compressible insert 80 can be accomplished using multiple approaches. For example, the compressible insert 80 is shown herein as a sponge or other compressible foam-like material. In addition, the compressible insert 80 could comprise a spring made from metal, plastic, rubber or other compressible material. The compressible insert 80 is deployed within the cavity 32 along its deeper portion 72. In other versions, the compressible insert 80 may be removable and/or replaceable to accommodate different sized earbuds and different sized cavities. Thus, the same earphone assembly organizer 10 may be used for different sizes and types of earbuds 44 by merely changing out the compressible insert 80.

In another version, the organizer 10 includes a separate replaceable insert (not shown) that may be inserted into the storage cavity 32 to accommodate the specific dimensions of one or more earbuds.

Referring now to FIG. 11, an illustration of one method for insertion and storage of an earbud 44 within an opening 22 is shown. In one instance, the method of insertion is applicable to earbud designs associated with the !PHONE 5 where the stem 41 of each earbud 44 is slightly offset from the center of the earbud 44, creating a longer portion 94 and shorter portion 95 of the earbud 44. Now, to install the earbud 44 in the opening 22, the longer portion 94 of the earbud 44 is first tilted and inserted into the deeper portion 72 of the storage cavity 32. Then the shorter portion 95 of the earbud 44 is tilted and inserted into the shallower portion 74 of the storage cavity 32. After full insertion, the earbud 44 is rotated within the storage cavity so that the stem 41 of the earbud 44 is directed downward toward the nose protrusion 26 of the face 20, capturing the earbud 44 within the opening 22. After insertion of earbuds 44, the earpiece cords 45 of the earphone assembly 40 extending from each earbud 44 are preferably draped on either side of the nose protrusion 26 in preparation for wrapping about the organizer 10.

Once the earbud 44 is fully inserted through the opening 22 and into the storage cavity 32, and, the earbud 44 is rotated to capture the earbud 44 behind the opening 22, the earbud 44 cannot be removed from the storage cavity 32 without first reversing the rotation and removal process. Thus, a user need not hold the earbuds 44 in place in the cavity 32 while attempting to wrap the remainder of the earphone assembly 40 about the organizer 10. With the earphone assembly 40 hanging downward, each earbud 44 will be secured within its cavity 32 since the diameter D2 of each earbud 44 in this installed position is greater than the diameter D1 of the opening 22.

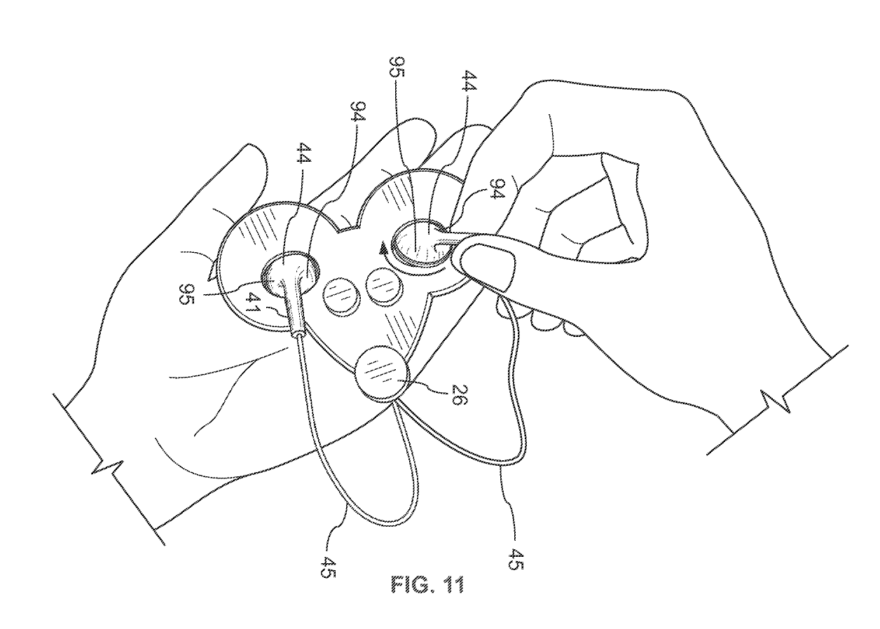

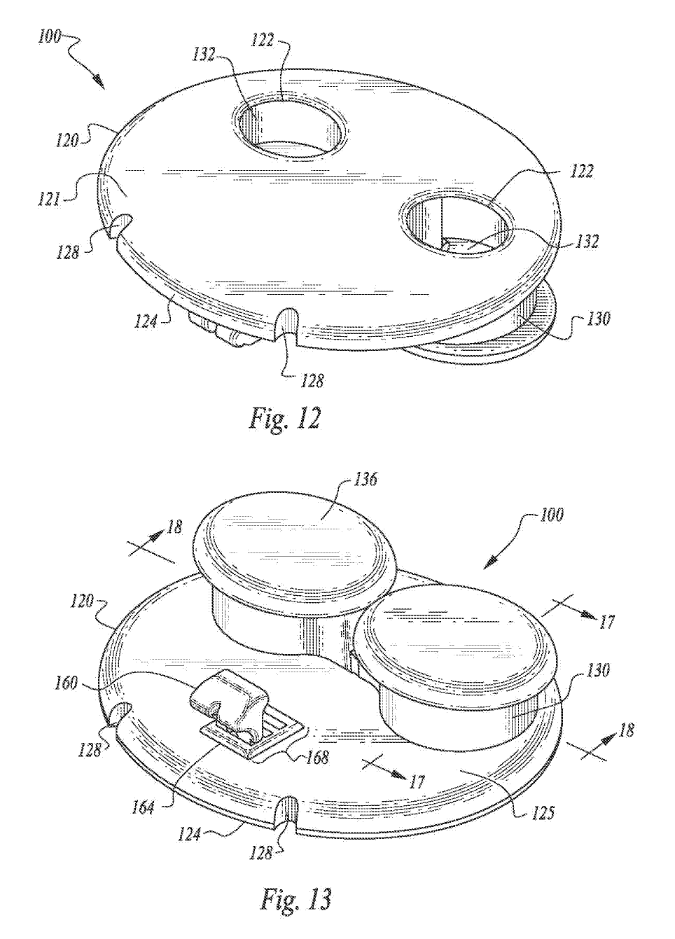

Turning now to FIGS. 12-18, a second exemplary embodiment of an earphone assembly organizer 100 comprised of separate individual modular components and in a first aspect, having a generic oval face 120, is described.

Referring to FIG. 12, a front perspective view of the earphone assembly organizer 100 according to the second exemplary embodiment of the invention is shown. In this second embodiment, the face 120 of the earphone assembly organizer 100 is shown as having a generic oval shape. Two openings 122 penetrating the face 120 are sized to accommodate earbuds 44. Although shown as having a generically oval shape, the face 120 may be shaped to suit various aesthetic and other functional configurations, as long as the face 120 is sized to accommodate the two openings 122 in a front surface 121 of the face 120. A body 130 of the earphone assembly organizer 100 includes two storage cavities 132 positioned beneath and accessible via the openings 122. During use, the earbuds 44 are secured and rest in the storage cavities 132 of the earphone assembly organizer 100.

In another aspect, the face 120 includes two short grooves or indentations 128 along an edge 124 of the face 120 sized to receive and separate the earpiece cords 45 of the cord 40. The grooves 128 serve to neatly orient and separate the earbuds 44 and earpiece cords 45 while the earbuds 44 are engaged in the storage cavities 132. Although shown as two separate grooves 128, the face 120 could also include a singular indented or protruded portion in the same area along the edge 124 of the face 120 for aligning the earpiece cords 45 of the earbuds 44. In addition, the grooves 128 may be less pronounced with a wider mouth and/or shallower depth. Further, the grooves 128 may have a narrower mouth sized to require that some pressure be applied to the earpiece cords 45 of earphone assembly 40 to set them in the grooves 128.

Now referring to FIG. 13, a perspective view of a reverse side of the earphone assembly organizer 100 of FIG. 12 is shown. In this orientation, the organizer 100 may be used to prop an object, including an electronic device, such as a cell phone C, at a desired angle of repose. As illustrated, the body 130 is joined to the rear surface 125 of the face 120. The body 130 includes a base surface 136. A brace receiver 164 is positioned in the rear surface 125 of the face 120. The brace receiver 164 includes one or more notches 168 to receive a brace 160. In use, the brace 160 is pressed into one of the notches 168 in the receiver 164 in the rear surface 125 of the face 120. A smartphone, mobile phone, similar electronic device or other object may then be placed upright on the rear surface 125 between and against the body 130 and the brace 160. A user may place the brace 160 in any of the notches 168, according to the size of a device and the desired angle of repose. The brace receiver 164 may be modified to provide additional notches 168 to accommodate differently sized braces 160. The different braces 160 may be designed to accommodate various phone models, sizes, phone cases, display angles, and display orientations. Additionally, although shown herein as the brace 160 sized to frictionally fit within notches 168 of the brace receiver 164, other interlocking mechanisms can be used to mate the brace 160 with the brace receiver 164. Such other interlocking mechanisms can include different shape profiles that allow the brace 160 to mate with the brace receiver 164 at various locations on the brace receiver 164.

Now referring to FIG. 14, an exploded view of the modular embodiment of the earphone assembly organizer 100 from the same perspective as shown in FIG. 13 is illustrated. The exploded view illustrates one of several configurations and structures used to manufacture and assemble the modular embodiment of the earphone assembly organizer 100. As illustrated, the organizer 100 is comprised of separate individual components, which may be manufactured as two separate pieces and subsequently assembled to create a complete earphone assembly organizer 100 using standard manufacturing and assembly techniques. In addition, one skilled in the art will recognize that various portions of the illustrated components may be manufactured as combined integral pieces that are subsequently joined with other pieces. Thus configured in a modular assembly, the organizer 100 may be assembled from different sized pieces to accommodate different earphone configurations. Such assembly of the organizer 100 may be performed at a manufacturing site, prior to retail distribution to consumers. Alternatively, a kit of components may be provided to consumers with portions that may be exchanged and/or replaced to accommodate specific headphones or the taste of the consumer.

For this second embodiment, great flexibility is enjoyed by providing the different elements of the organizer 100 as modular, replaceable and exchangeable components. The joining or engagement of the various modular components may be accomplished at a manufacturing site using standard joining techniques. If provided as a kit to a consumer, the modular components may be engaged using various friction fit engagement methods, or, for example, using an adhesive. Frictional engagement allows the organizer 100 to be disassembled to allow parts to be replaced or changed, as desired.

The face 120 and body 130 will typically comprise separate elements, which are subsequently engaged to form one assembly. The face 120 contains two oval openings 122. The face 120 may be produced with different sized or shaped openings 122 to accommodate specific types of earbuds 44. The rear surface 125 of the face 120 includes a mounting recess 166 for installing a brace receiver 164. As with the openings 122, the mounting recess 166 may be sized to receive different types and sizes of brace receivers 164. When assembled, the brace receiver 164 lies generally flush with the rear surface 125 of the face 120. The brace receiver 164 is incised by a plurality of parallel notches 168. A removable brace 160 may be inserted into any one of the notches 168 by the user in order to allow the earphone assembly organizer 100 serve as a stand while in an inverted position to hold and secure a mobile phone, smartphone, or other similar electronic device.

The oval openings 122 are sized to receive and join with two opposite but identical cavity inserts 180, 190. The cavity inserts 180, 190 and openings 122 are sized and positioned such that when the earphone assembly organizer 100 is assembled, two storage cavities 132 are formed adjacent to the two openings 122 for receiving and securing earbuds 44. In this second embodiment, the cavity inserts 180, 190 are separate elements that are engaged or attached to the rear surface of the face 120 and body 130 to form a full assembly. Around the openings 122, the rear surface 125 of the face 120 includes a mating depression 127 sized to securely receive the body 130, containing the cavity inserts 180, 190. When assembled, the face 120, the body 130, the brace receiver 164, and the cavity inserts 180, 190 are engaged to form one assembly. In a preferred embodiment, the face 120 is removable from the body 130 by the user, allowing the user to replace the face 120 with a different face 120 for various reasons, such as to use a face 120 with a different design, or to replace a face 120 that has become worn or damaged.

In another version, the body 130 and cavity inserts 180, 190 and may be formed as one unitary component. In yet another version, the face 120 and cavity inserts 180, 190 may be formed as one unitary component. By manufacturing one or more of the face 120, body 130 and cavity inserts 180, 190, as one component, the assembly of the earphone assembly organizer 100 will be simplified, involving fewer parts.

Now referring to FIG. 15, an exploded view of the body 130 and cavity inserts 180, 190 of the earphone assembly organizer 100 of FIG. 12 is shown. In this embodiment, the cavity inserts 180, 190 and body 130 are separate elements that are engaged to form the final assembly of the earphone assembly organizer 100. The organizer 100 includes a left cavity insert 180 and right cavity insert 190. Each cavity insert 180, 190 differs in orientation of its sloping angled surface 184, 194 in relation to the rear surface 125 of the face 120. Each cavity insert 180, 190 has a protrusion 182, 192, which helps to secure the cavity insert 180, 190 in place in a receptacle 138 in the body 130. The perimeter shape of each cavity insert 180, 190 mates with the shape of an inner wall 139 of the receptacle 138, preventing rotation, as well as indicating proper alignment and position of each cavity insert 180, 190 to form storage cavities 132 in the body 130 of the earphone assembly organizer 100.

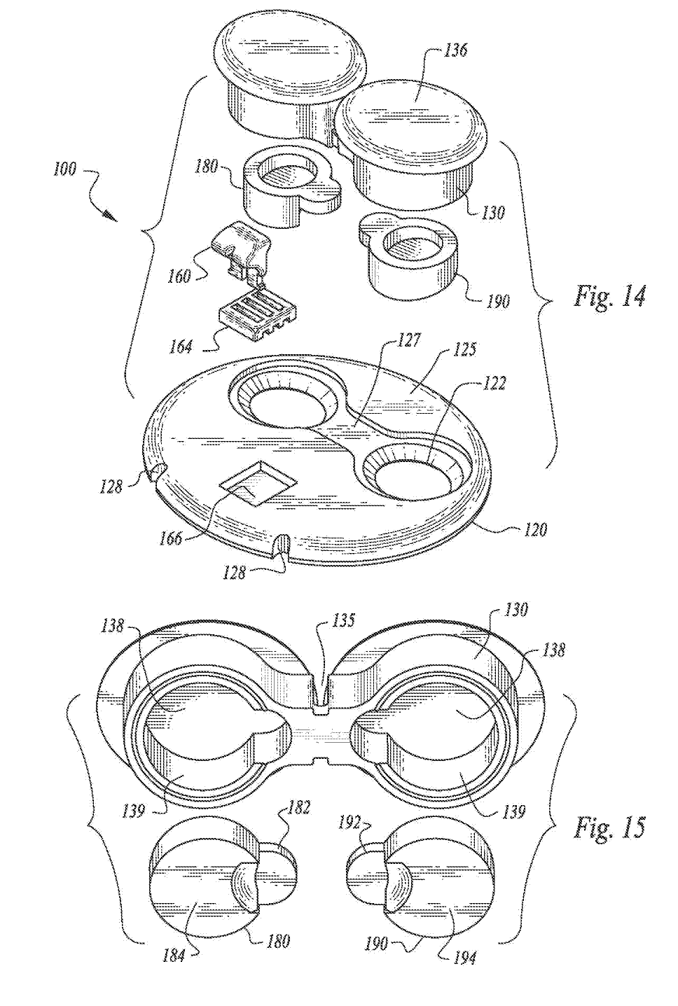

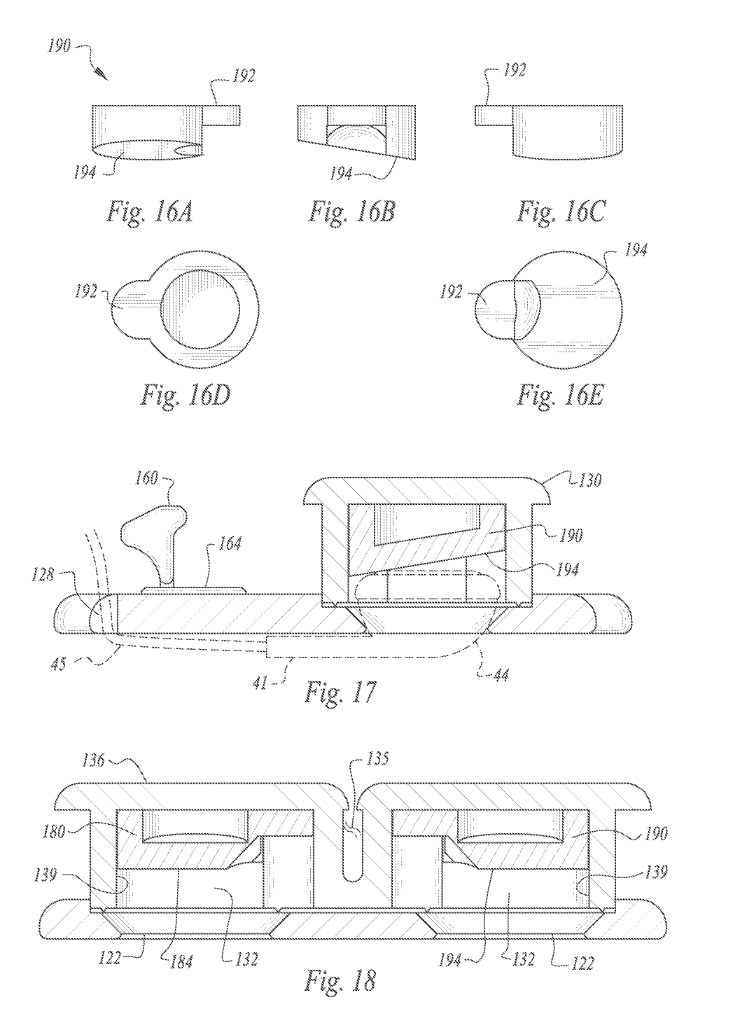

Referring now to FIGS. 16A-16E, various views of the right cavity insert 190 of the earphone assembly organizer of FIG. 12 are shown. FIG. 16A is a left elevation view of cavity insert 190. Each cavity insert 190 has a protrusion 192 to orient and secure the cavity insert 190 in place inside an inner wall 139 of the receptacle 138 of body 130. Each cavity insert 180, 190 includes a sloping angled surface 184, 194, respectively. FIG. 16B is a front elevation view of the cavity insert 190. The angled face 194 serves as the bottom of the shaped storage cavity 132 in the earphone assembly organizer 100 when assembled. FIG. 16C is a right elevation view of the cavity insert 190 showing the circular-shaped protrusion 192. FIG. 16D is a top plan view of the cavity insert 190. FIG. 16E is a bottom plan view of the cavity insert 190.

Now, in even greater detail, we refer to FIG. 17 and FIG. 18 which provide sectional detailed views of the interior of the organizer 100. FIG. 17 provides a sectional view of the assembled earphone assembly organizer 100 shown in FIG. 13 taken along the cutting plane described by section line 17-17. FIG. 18 provides a sectional view of the assembled earphone assembly organizer 100 shown in FIG. 13 taken along the cutting plane described by section line 18-18. The body 130 of the earphone assembly organizer 100 is secured within the mating depression 127 in the rear surface 125 of the face 120 above two openings 122. The body 130 houses cavity inserts 180, 190. An earbud 44 (shown in phantom lines) may be stored within an opening 122 adjacent a cavity insert 190.

Each storage cavity 132 is formed by the angled surface 184, 194 of the respective cavity insert 180, 190, an inner wall 139 of a receptacle 138 of the body 130, and an opening 122. For most earbuds 44, a top of the earphone 44 rests in the deeper portion of the cavity 132. Each opening 122 and storage cavity 132 is shaped such that an earbud 44 is secured and cannot be easily removed by the application of gravity or other external forces unless rotated or angled, which prevents accidental or unintentional removal. A removable brace 160 is attached to the brace receiver 164 for use as a stand.

In further detail, the section illustrated in FIG. 18 shows storage cavities 132 formed by assembly of the body 130, the face 120 having two openings 122, and cavity inserts 180, 190. The body 130 includes a bisecting retention slot 135 used to secure earpiece cords 45 and the main cord 47 to the body 130 when in use. The earpiece cords 45 and main cord 47 are pressed down into the retention slot 135 and wrapped about the perimeter of the body 130 of the earphone assembly organizer 100 such that the earpiece cords 45 and main cord 47 are secured between the face 120 and the base 136.

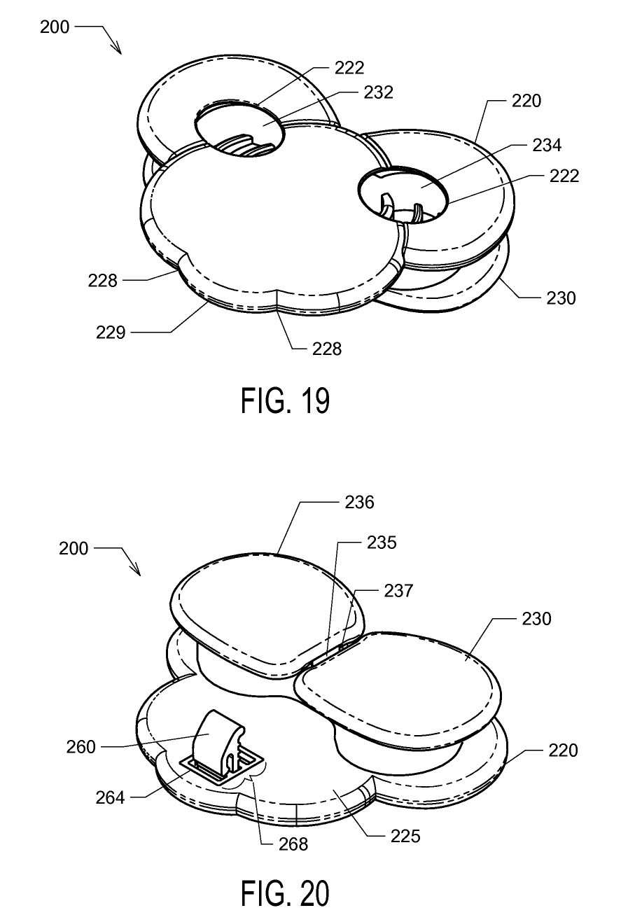

Turning now to FIGS. 19-28, a third embodiment of an earphone assembly organizer 200 having an alternative interior cavity configuration is described. Referring to FIG. 19, a front perspective view of the earphone assembly organizer 200 according to the third exemplary embodiment of the invention is shown. In this third embodiment, a face 220 of the earphone assembly organizer 200 is shown as having a more circular shape with circular ear-like portions. Two openings 222 penetrating the face 220 are sized to accommodate earbuds 44. A body 230 of the organizer 200 supports two storage cavities 232, 234 positioned beneath the openings 222. The earbuds 44 are secured and rest in the storage cavities 232 during use of the earphone assembly organizer 200. In another aspect, the face 220 includes two slight jaw recesses 228 on each side of a chin 229 sized to receive and separate the earpiece cords 45 from the earbuds 44. The jaw recesses 228 and the protruding chin 229 serve to orient the earbuds 44 and earpiece cords 45 while the earbuds 44 are engaged in storage cavities 232 through the openings 222 of the organizer 200.

Now referring to FIG. 20, a perspective view of a reverse side of the earphone assembly organizer 200 of FIG. 19 is shown. In the orientation illustrated in FIG. 20 with the rear surface 225 of the face 220 facing upward, the organizer 200 may be used to prop an object, including an electronic device, such as a cell phone, at a desired angle of repose, in a manner consistent with that shown in FIG. 8. As illustrated, the body 230 is joined to the rear surface 225 of the face 220. The body 230 includes a base 236. The base 236 is bisected by a retention slot 235 having a crimping portion 237. When being wrapped for storage, the earpiece cords 45 and main cord 47 may be pressed into the retention slot 235 and wrapped about the perimeter of the body 230 of the earphone assembly organizer 200 such that the earpiece cords 45 and main cord 47 are secured between the rear surface 225 of the face 220 and the base 236. Wrapped in such a manner, the face 220 is not obscured.

A brace receiver 264 is situated in the rear surface 225 of the face 220 in close proximity to and preferably centrally aligned with the chin 229. The brace receiver 264 includes one or more notches 268 to receive a brace 260. In use, the brace 260 is pressed into one of the notches 268 in the brace receiver 264 in the rear surface 225 of the face 220. As illustrated in FIG. 8, a smartphone, mobile phone, similar electronic device or other object may then be placed upright on the rear surface 225 against the base 236 and the brace 260. A user may place the brace 260 in any of the notches 268, according to the size of a device and the desired angle of repose. The brace receiver 264 may be modified to provide additional notches 268 to accommodate differently sized braces. The different braces may be designed to accommodate various phone models, sizes, phone cases, display angles, and display orientations. Additionally, although the brace 260 may be sized to frictionally fit within notches 268 of the brace receiver 264, other interlocking mechanisms can be used to mate the brace 260 with the brace receiver 264. Such other interlocking mechanisms can include different shape profiles that allow the brace 260 to mate with the brace receiver 264 at various locations on the brace receiver 264.

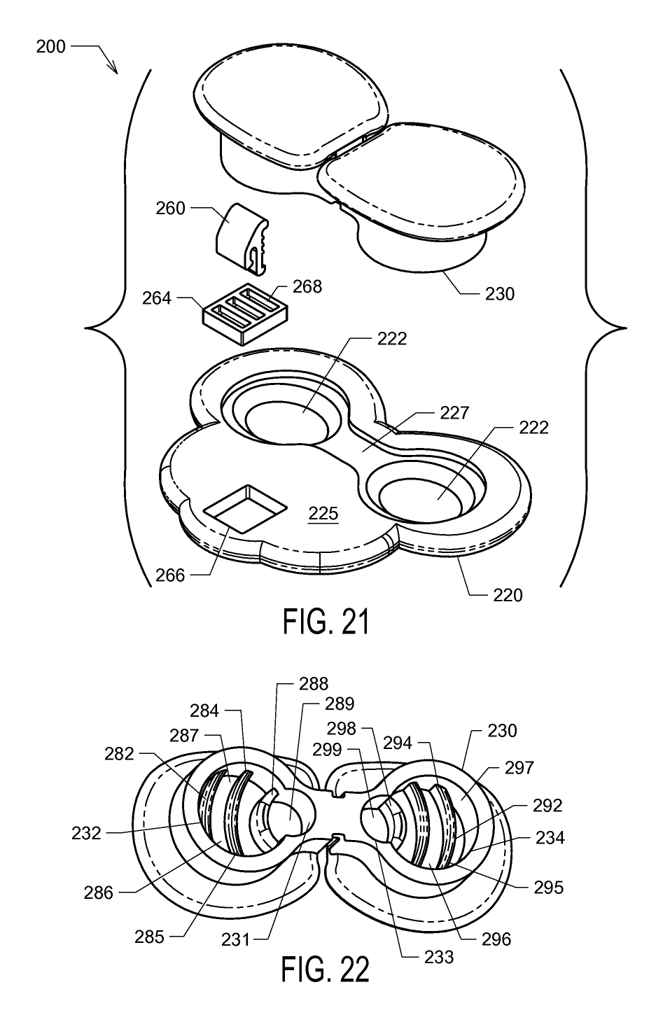

Now referring to FIG. 21, an exploded view of the earphone assembly organizer 200 from the same perspective as shown in FIG. 20 is illustrated. FIG. 21 illustrates one of several configurations and structures used to manufacture and assemble the modular embodiment of the earphone assembly organizer 200. As illustrated, the organizer 200 comprises the face 220, the body 230, the brace 260 and the brace receiver 264. The organizer 200 may be assembled from different sized pieces to accommodate different earphone configurations. Such assembly of the organizer 200 may be performed at a manufacturing site, prior to retail distribution to consumers. Alternatively, a kit of components may be provided to consumers with portions that may be exchanged and/or replaced to accommodate specific headphones or the taste of the consumer.

The face 220 includes two oval openings 222. The face 220 may be produced with different sized or shaped openings 222 to accommodate specific types of earbuds 44. The rear surface 225 of the face 220 includes a mounting recess 266 for the brace receiver 264. As with the openings 222, the mounting recess 266 may be sized to receive different types and sizes of brace receivers 264. When assembled, the surface of the brace receiver 264 lies generally flush with the rear surface 225 of the face 220. The brace receiver 264 is incised by a plurality of parallel notches 268 such that when the earphone assembly organizer 200 is assembled, a removable brace 260 may be inserted into any one of the notches 268 by the user in order to allow the earphone assembly organizer 200 to hold and secure a mobile phone, smartphone, or similar electronic device.

The rear surface 225 of the face 220 includes a mating depression 227 sized to securely receive the body 230. In a preferred embodiment, the face 220 is removable from the body 230 by the user, allowing the user to replace the face 220 with a different face 220 for various reasons, such as to use a face 220 with a different design, or to replace a face 220 that has become worn or damaged.

Referring now to FIG. 22, the configuration and function of the body 230 and its storage cavities 232, 234 are described in greater detail. A first storage cavity 232 within the body 230 includes one or more tapered ribs 282 that form the supporting structure of the first storage cavity 232. A second storage cavity 234 likewise includes one or more tapered ribs 292 that form the supporting structure of the second storage cavity 234. Each rib 282, 292 tapers from a wide end 284, 294 to a narrow end 285, 295, thus creating a deeper portion 286, 296 and a shallower portion 287, 297 in the respective storage cavities 232, 234.

Each storage cavity 232, 234 may also include a centric proximal rib 288, 298 sized and shaped to form a secondary storage cavity 289, 299 to hold and secure ear plugs 43. Each centric proximal rib 288, 298 together in conjunction with a nasal wall 231, 233 of each cavity 232, 234 and the rear surface 225 of the face 220, forms a constrained volume to compress and secure ear plugs 43 using frictional engagement and/or suction. The shape of each centric proximal rib 288, 298 and corresponding nasal wall 231, 233 is such that it maximizes friction or suction when earplugs 43 are inserted, but does not obstruct the storage of earbuds 44.

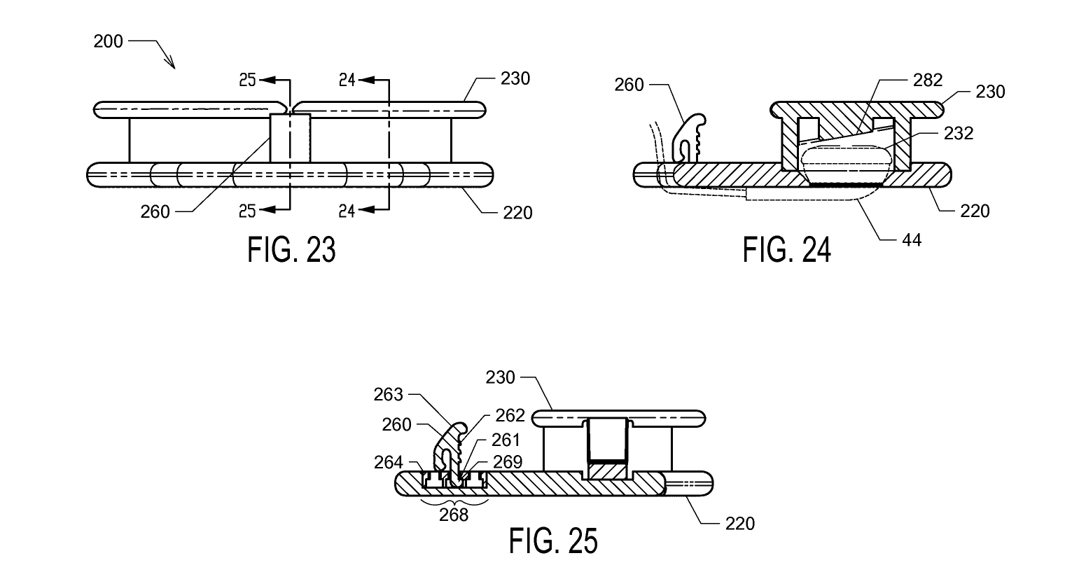

FIGS. 23, 24 and 25 serve to illustrate the interior of the organizer 200. FIG. 23 is a front elevation view of the organizer 200 in an inverted position. FIG. 24 is a sectional view of FIG. 23 taken along section line 24-24 revealing the interior of storage cavity 232 and the pitched support surface created by the tapered ribs 282. An earbud 44 shown in phantom lines illustrates the typical storage position within the storage cavity 232 of the organizer 200.

Now in greater detail, FIG. 25 is a sectional view of FIG. 23 taken along section line 25-25, illustrating the means of engagement between the phone brace 260 within one of the notches 268 of the brace receiver 264. The phone brace 260 includes a male latch feature 261, which extends underneath a mating female latch feature 269 in the notch 268. When a cell phone is positioned upright between the phone brace 260 and the body 230 of the organizer 200, the bottom front edge of the cell phone C is engaged by the phone latch portion 262 of the brace 260. The upward and outward force created by the weight and pressure from the placement of the cell phone C in the organizer 200 causes the male latch feature 261 to engage with the mating female latch feature 269. This engagement holds the phone brace 260 within notch 268, thus maintaining phone stand functionality. When the user wants to move the phone brace 260 into a different notch 268, the user will press a top 263 of the phone brace 260 upward and towards the body 230 until the brace 260 is disengaged from the notch 268.

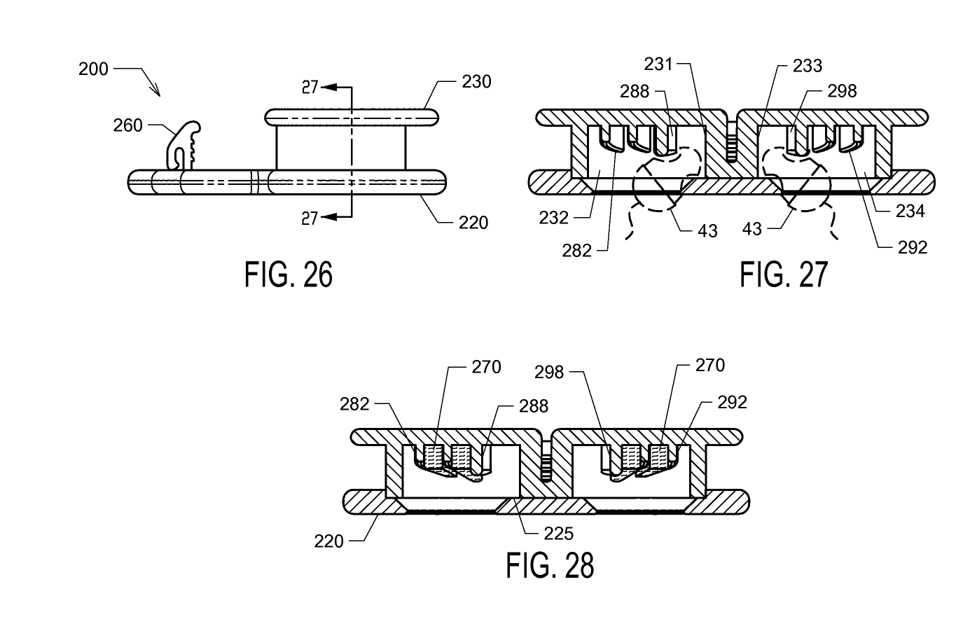

FIGS. 26, 27 and 28 serve to illustrate the interior of the organizer 200 from a different viewpoint. FIG. 26 is a side elevation view of the organizer 200 in an inverted position. FIG. 27 is a sectional view of FIG. 26 taken along section line 27-27 revealing the interior of storage cavities 232, 234 and illustrating the pitched support surface created by the tapered ribs 282, 292 and the constrained volume created by centric proximal ribs 288, 298 and nasal walls 231, 233 for storage and retention of ear plugs 43. The number, size and spacing of tapered ribs 282, 292 are variable to create different cavity configurations and sizes, along with changing the force required to depress the tapered ribs 282, 292 when inserting ear buds 44 in the storage cavities 232, 234.

FIG. 28 is the same cross-sectional view as that shown in FIG. 27, with the inclusion of compressible spacers 270 positioned between the ribs 282, 292, 288, 298. The compressible spacers 270 may be made of a soft material, such as foam or rubber. The compressible spacers 270 may be sized to extend slightly above the ribs 282, 292, 288, 298 to provide a softer compressible surface to serve as a softer contact point when earplugs 43 or earbuds 44 are stored in the organizer 200. When inserting either earplugs 43 or earbuds 44 in the storage cavities 232, 234 of the organizer 200, which begins to compress the compressible spacers 270, the compressible spacers 270 push back on the earplugs 43 or earbuds 44 to hold more securely. The compressible spacers push the earbuds 44 against the rear surface 225 of the face 220 to reduce movement of the earbuds 44 and hold them in position when stowing the earphone assembly 40 on the organizer 200.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

I claim:

1. An earphone assembly cord organizer comprising:
(a) a face, including
(i) a front surface; and
(ii) a rear surface;
(b) said face having two oval openings, each of said two oval openings including
(i) an upper edge; and
(ii) a lower edge;
(c) said face joined to a body, said body including
(i) a base;
(ii) a wrapping surface extending from said base, said wrapping surface sized to receive multiple wrappings of an earphone cord for storage;
(iii) a retention slot bisecting said body, said retention slot sized to secure said earphone cord; and
(iv) a storage cavity adjacent to and accessible via each of said two oval openings sized to secure an earphone.

2. The earphone assembly cord organizer of claim 1 wherein a distance between said upper edge and said lower edge of each of said two oval openings is less than a diameter of said earphone.

3. The earphone assembly cord organizer of claim 1 wherein said earphone is an earplug.

4. The earphone assembly cord organizer of claim 1 wherein said earphone is an earbud.

5. An earphone assembly cord organizer comprising:
(a) a face, including
(i) a front surface; and
(ii) a rear surface;
(b) said face penetrated by two oval openings, each of said two oval openings including
(i) a upper edge; and
(ii) a lower edge; and
(c) a body, including
(i) a base;
(ii) a wrapping surface extending from said base, said wrapping surface having a minimum radius of curvature;
(iii) a retention slot bisecting said body, said retention slot including a crimping portion; and
(iv) two storage cavities, each of said two storage cavities sized to receive an earphone of an earphone assembly.

6. An earphone assembly cord organizer according to claim 5 wherein:
(a) said earphone is secured via size differential and frictional engagement;
(b) said earphone is inserted through one of said two oval openings and into one of said two storage cavities for storage;
(c) said earphone is rotationally inserted into one of said two storage cavities;
(d) said earphone is tilted and twisted to fit through one of said two oval openings and secured within one of said two storage cavities;
(e) wherein said wrapping surface is sized to receive multiple wrappings of said earphone assembly for storage such that said front surface of said face is not obscured by said multiple wrappings;
(f) wherein said retention slot is sized to secure earphone cords of said earphone assembly;
(g) wherein said crimping portion requires additional force to press a main cord through said crimping portion and into said retention slot; and
(h) wherein said crimping portion is sized to ensure that said earphone cords of said earphone assembly are securely retained about said wrapping surface and in said retention slot.

7. The earphone assembly cord organizer of claim 5, wherein said minimum radius of curvature of said wrapping surface is greater than a minimum radius of curvature to avoid damaging said earphone assembly.

8. The earphone assembly cord organizer of claim 5, wherein said face and said body are manufactured as one unitary piece.

9. The earphone assembly cord organizer of claim 5, wherein said face and said body are manufactured as two separate pieces.

10. The earphone assembly cord organizer of claim 5, wherein said retention slot is sized to receive and hold an earphone jack of said earphone assembly.

11. The earphone assembly cord organizer of claim 5, wherein said front surface is configurable to provide a plurality of designs according to preferences of a purchaser.

12. The earphone assembly cord organizer of claim 5, wherein said face is removable from said body and said face may be replaced with a different face having a different design.

13. The earphone assembly cord organizer of claim 5, wherein said face includes one or more protrusions extending from said face, said one or more protrusions configured to level said earphone assembly cord organizer when inverted to serve as a mobile phone stand.

14. The earphone assembly cord organizer of claim 5, wherein each of said two storage cavities includes a pitched floor forming a deeper portion and a shallower portion within each of said two storage cavities, said pitched floor sized to allow a first edge of said earphone to be inserted into said deeper portion of each of said two storage cavities and an opposing edge of said earphone may pass into each of said two storage cavities.

15. The earphone assembly cord organizer of claim 5 wherein each of said storage cavities includes a compressible insert for securing said earphones within said storage cavities.

16. The earphone assembly cord organizer of claim 5, wherein said rear surface of said face includes one or more notches, said one or more notches sized to receive a brace to support a cell phone at one or more angles on the cord organizer.

17. The earphone assembly cord organizer of claim 5, wherein said earphone assembly cord organizer is scalable in size and dimension to accommodate varying earphone assemblies.

18. The earphone assembly cord organizer of claim 5, including:
(a) a removable brace;
(b) wherein said rear surface of said face includes one or more notches; and
(c) wherein said removable brace, when pressed into one of said notches, holds a cell phone upright at a desired angle.

19. The earphone assembly cord organizer of claim 18 wherein said removable brace includes a male latch feature and each of said notches includes a female latch feature, said male latch feature mating with said female latch feature of one of said notches to secure said removable brace in one of said notches.

20. The earphone assembly cord organizer of claim 18 wherein said removable brace includes one or more phone latch portions.

21. The earphone assembly cord organizer of claim 5, wherein said earphone assembly cord organizer includes:
(a) a carry loop, said carry loop engageable within said retention slot on said body and detachable from said retention slot; and,
(b) a removable brace, said removable brace attachable to said carry loop.

22. A method of organizing an earphone assembly having two earphones on an earphone assembly organizer, comprising the steps of:
(a) securing each of said two earphones by tilting and rotational insertion into openings in a face of said earphone assembly organizer;
(b) wrapping individual earpiece cords extending from each of said two earphones underneath said face and around a body of said earphone assembly organizer along a wrapping surface;
(c) continuing to wrap a main cord of said earphone assembly around said body and along said wrapping surface; and
(d) pressing a portion of said main cord into a retention slot to secure said main cord, said individual earpiece cords, and said two earphones in said earphone assembly organizer.

23. The method of claim 22, wherein said face and a base of said body serve as guides to ensure that said earphone assembly remains in place on said wrapping surface of said body during storage.
